(19) United States
(12) Patent Application Publication
(10) Pub. No.: US 2008/0005080 A1
(43) Pub. Date: Jan. 3, 2008

(54) INTERACTIVE FACSIMILE DIRECTORY

(75) Inventors: Albert E. Xiques, Chicago, IL (US); Jose E. Lamas, Chicago, IL (US)

Correspondence Address: Levenfeld Pearlstein, LLC;Intellectual Property Department, 2 North LaSalle, Suite 1300, Chicago, IL, 60602, US

(73) Assignee: WHATSTHEFAX, LLC, Chicago, IL (US)

(21) Appl. No.: 11/428,364

(22) Filed: Jun. 30, 2006

(51) Int. Cl. G06F 17/30

(52) U.S. Cl. 707/3

(57) ABSTRACT

An interactive electronic facsimile directory consists of four primary components: (a) a registration module for permitting businesses and individuals to register to list their fax numbers and other contact information in the directory; (b) a login module for permitting registered businesses and individuals to access and modify their fax numbers and other information; (c) a search module for permitting users to search the directory; and, (d) a database for storing data used by the three preceding modules. The registration module, the login module, the search module and the database are interactively coupled and reside on a web server computer, and the registration module, login module, and search module utilize structured query language (“SQL”) to communicate with the database and to store, retrieve and modify data from database as needed. Unlike prior art printed and online databases, the interactive electronic facsimile directory of the present invention provides a centralized directory of fax numbers that are otherwise unavailable from a single source and allows business and individuals to instantaneously update the contact information available in the directory without the typical publication delay associated with prior art directories.

### BACKGROUND OF THE INVENTION

The present invention relates generally to electronic directories and more particularly to an interactive electronic facsimile directory.

It is well known in the prior art to publish printed directories containing contact information for businesses and individuals. Such directories, such as the ubiquitous “Yellow Page” directories of business telephone numbers and addresses, and the “White Pages” directories of personal telephone numbers and addresses, are commonplace resources in nearly all homes and businesses.

Traditionally, such directories are printed publications that are geographically-limited by city, county or region, for example. Often, such directories are updated and published on an annual basis. Thus, the contact information contained in the directories readily may become outdated, as people and businesses move, area codes change and the like. This is a particularly serious problem for businesses that rely on the accuracy of the data in such directories to attract customers and derive income. A delay of only days or weeks in updating the contact information in a business directory listing may result in significant lost sales.

Further, due to their typical size, publication and distribution costs for such printed directories can be quite high. Additionally, as the number of individuals and businesses grow within a geographic area, the size of the directories correspondingly increases, making the directories cumbersome to use and store.

With the popularity of the Internet, various online directories have emerged to address some of the issues plaguing traditional printed directories. For example, online directories now allow users to search across vast geographic areas, locally, nationally and even internationally. Further, online directories offer advanced search functions, such as the ability to search by complete or partial names, phone numbers or addresses. Online directories also offer significantly reduced production and distribution costs as compared to traditional paper directories.

However, since most online directories are based on the data contained in their printed counterparts, the currency of such data often is limited and the data many times is out-of-date. Similarly, much like their printed counterparts, most existing online directories are static, and cannot be interactively and instantaneously updated by the businesses and individuals whose information is listed in the directories. Moreover, such online directories are of limited use to those seeking information that traditionally does not appear in printed directories, such as facsimile (“fax”) numbers, cellular phone numbers, email addresses and the like.

Fax machines already are an integral part of nearly all businesses, and it is becoming increasingly common for individuals also to maintain fax machines at their homes. Coupled with the explosion of online “virtual” fax machine services (in which a business or individual may lease a fax number to receive faxes which then are converted to an appropriate image format and sent as an attachment to a desired email address), the need for a directory of fax numbers becomes paramount.

The availability of traditionally unpublished information, such as fax numbers, in an online directory would be a significant advantage over the prior art and would offer a substantial benefit to both businesses and individuals. For example, those needing to fax important, time-sensitive documents to lawyers, doctors, insurance companies, realtors and the like would benefit from such an online directory in the event that a particular fax number is lost or unknown and the business or individual receiving the fax is closed or unavailable. Moreover, the availability of such traditionally unpublished information in an interactive online directory would permit businesses and individuals to instantaneously update their contact information without the lag associated with prior art print and online directories.

Accordingly, there exists a need for an interactive electronic facsimile directory. Such an interactive electronic facsimile directory permits businesses and individuals to list their fax numbers in an online searchable database. Desirably, the interactive electronic facsimile directory also allows businesses and individuals to list other public contact information, such as addresses, telephone numbers, cellular phone numbers, email addresses and the like, to the online searchable database. More desirably, the interactive electronic facsimile directory is updateable online to allow the businesses and individuals to update their fax numbers and public contact information as needed, and to permit the updated information to be instantaneously available to those searching the directory.

### BRIEF SUMMARY OF THE INVENTION

The interactive electronic facsimile directory of the present invention consists, in the preferred embodiment, of four primary components: (a) a registration module for permitting businesses and individuals to register to list their fax numbers and other contact information in the directory; (b) a login module for permitting registered businesses and individuals to access and modify their fax numbers and other contact information; (c) a search module for permitting users to search the directory; and, (d) a database for storing data used by the three preceding modules.

In the preferred embodiment of the interactive electronic facsimile directory of the present invention, the registration module, the login module, the search module and the database are interactively coupled and reside on a single web server computer, of the type commonly known and used in the prior art, which is connected to a global computer network, such as the Internet, through traditional prior art networking means. However, it will be appreciated that in other embodiments, the registration module, the login module, the search module and the database can be interactively coupled while stored on independent computers, if desired, without affecting the functionality of the invention and without departing from the scope of this disclosure.

The registration module is designed to allow businesses and individuals to register to list their fax number and other contact information in the interactive electronic facsimile directory and to enter their contact information in the directory. Using prior art means, the registration module allows such businesses and individuals to enter their contact information, including business and/or individual name, fax number and telephone number using a traditional web page data entry template. The registration module also permits businesses and individuals to establish a user name and password for future access to the directory.

In some embodiments, the registration module also validates and stores registration fee payment information, such as credit card numbers. Additionally, in some embodiments of the present invention, the registration module permits the businesses and individuals to enter additional contact information, such as an address, cell phone number, email address, website address and/or picture. The registration module interactively communicates with the database to accept, store, retrieve and modify the information received by the registration module.

The login module allows businesses and individuals registered through the registration module to access and modify their saved information. Using a traditional web page data entry template, the login module authenticates registered businesses and individuals by comparing a provided user name and password against the user names and passwords stored in the database. Authenticated businesses and individuals are presented with a summary of their stored information and given the opportunity to make any necessary modifications. The login module interactively communicates with the database to access and modify the contact and other information stored in the database.

The search module allows users of the directory seeking to locate a fax number to search the database by business and/or individual name or other criteria. Again using a traditional web page data entry template, the search module is programmed to allow a search to enter search criteria, such as a business or individual name. The search criteria entered by the user then are communicated to the database and the database conducts a query for any matching data. The database communicates the results of the query back to the search module which then displays the results to the user. The search module interactively communicates with the database to access the contact and other information stored in the database

The database comprises a plurality of database tables used to store various data related to the three modules. The database system and structure are well known in the prior art. The present invention comprises a normalized relational database wherein the database is programmed to store effectively different, but related, data for the registration module, the login module and the search module.

These and other features and advantages of the present invention will be apparent from the following detailed description and drawings in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a block diagram showing the basic components of the interactive facsimile directory of the present invention;

FIG. 2 is an exemplary data entry screen for entering basic information into the database of the interactive facsimile directory of the present invention;

FIG. 3 is an exemplary data entry screen for entering enhanced information into the database of the interactive facsimile directory of the present invention;

FIG. 4 is an exemplary data entry screen for entering premium information into the database of the interactive facsimile directory of the present invention;

FIG. 5 is an exemplary data entry screen for entering a user name and password to register for and to modify the data contained in the interactive facsimile directory of the present invention;

FIG. 6 is a flowchart showing the general operation of the interactive facsimile directory of the present invention;

FIG. 7 is an exemplary data entry screen for searching for a fax number and other contact information in the interactive facsimile directory of the present invention; and,

FIG. 8 is an exemplary database schema illustrating the design of the database in the interactive facsimile directory of the present invention.

### DETAILED DESCRIPTION OF THE INVENTION

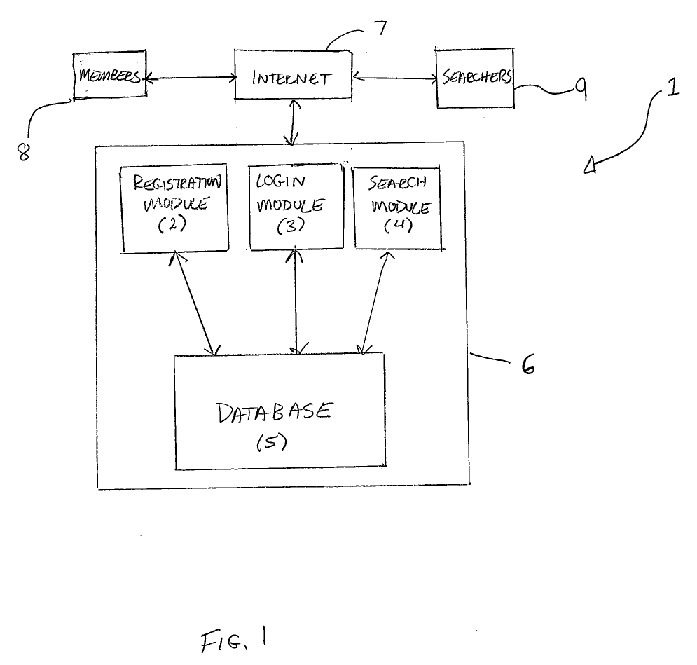

As shown in FIG. 1, the interactive electronic facsimile directory 1 of the present invention consists of four primary components in the preferred embodiment: a registration module 2 for permitting businesses and individuals to register to use the interactive electronic facsimile directory 1 and to enter their contact information in the directory; a login module 3 for permitting registered businesses and individuals to access and modify their fax numbers and other information; a search module 4 for permitting users to search the directory; and, a database 5 for storing data used by the registration module, the login module and the search module.

In the preferred embodiment of the interactive electronic facsimile directory of the present invention, registration module 2, login module 3, search module 4 and database 5 are interactively coupled and reside on a single web server computer 6 which is connected to a global computer network, such as the Internet 7, through traditional prior art networking means. However, it will be appreciated that in other embodiments, registration module 2, login module 3, search module 4 and database 5 may be interactively coupled while stored on independent computers, if desired, without affecting the functionality of the invention and without departing from the scope of this disclosure.

In the preferred embodiment, the interactive electronic facsimile directory of the present invention operates on a Microsoft Windows Server 2003 Web Edition operating system using Microsoft Internet Information Server (“IIS”) 6.0 web server software. Registration module 2, login module 3, and search module 4 are programmed using Microsoft C# ASP.Net 2.0. Database 5 is created and maintained using Microsoft SQL Server 2003 Express Edition software in the preferred embodiment. The combination of the Microsoft Windows Server 2003 Web Edition operating system using the Microsoft Internet Information Server 6.0 and the Microsoft SQL Server 2003 Express Edition is well known in the prior art for operating web based database applications. Also known in the prior art is the use of Microsoft C# ASP.Net 2.0 to program web based applications.

Web server computer 6 is of the type commonly known and used in the prior art and includes a processor, memory, data storage means (such as a hard drive) and networking communications means for interactive communications across a global computer network, such as the Internet.

In the preferred embodiment, registration module 2, login module 3, and search module 4 utilize structured query language (“SQL”) to communicate with database 5 and to store, retrieve and modify data from database 5 as needed. However, it will be appreciated that design and implementation of registration module 2, login module 3, search module 4 and database 5 of the present invention may be achieved using any appropriate combination software and hardware, including alternate scripting languages such as ASP (“active server page”) or PHP, and/or alternate database software, such as Microsoft Access or MySQL, without departing from the spirit or scope of this disclosure.

Members 8 and searchers 9, as further discussed below, access the interactive electronic facsimile directory 1 of the present invention through Internet 7 using prior art means, such as a personal computer connected to Internet 7 and running a web browser, such as Internet Explorer or Firefox. The interactive electronic facsimile directory 1 may be accessed through the use of a particular uniform resource locator (“URL”) address.

Registration module 2 is programmed to allow businesses and individuals (hereinafter collectively referred to as “members”) to register to make their fax number and other contact information available in the interactive electronic facsimile directory 1 and to enter their contact information in the directory 1. In the preferred embodiment of the present invention, registration of members 8 is a prerequisite to members 8 being able make their fax numbers and other contact information available in the interactive electronic facsimile directory 1.

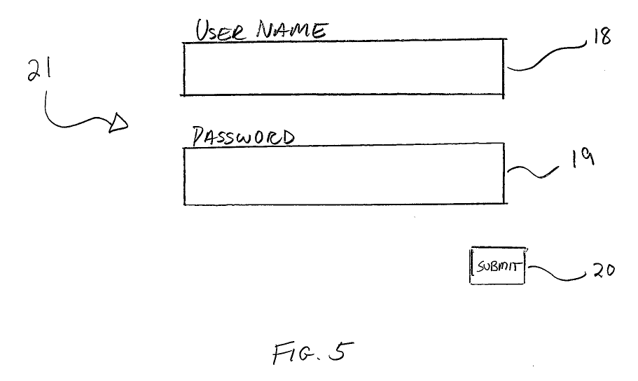

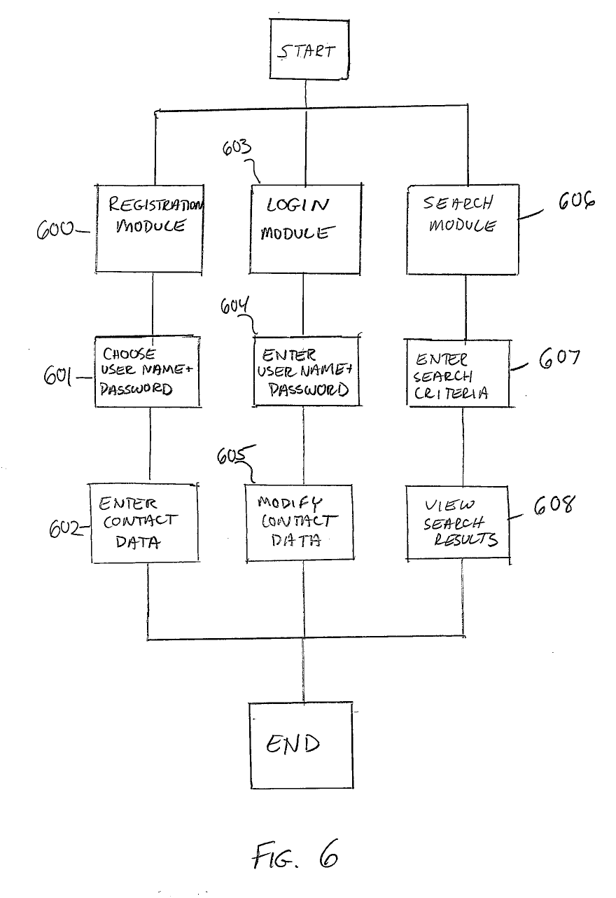

When member 8 chooses to register (600), as shown in FIGS. 5 and 6, registration module 2 presents member 8 with a basic user name web page data entry template 21 and prompts member 8 to choose a user name 18 and password 19 (601) to allow member 8 to log in to the interactive electronic facsimile directory 1 in the future in order to update the member's contact information, or to make other changes.

Once user name 18 and password 19 are entered, member 8 may click on submit button 20 to cause the data to be transferred to database 5 where it is checked against other stored user names to confirm no conflict exists. If identical user names are detected, member 8 is prompted to enter an alternate user name 18 and the confirmation process is repeated. Once user name 18 and password 19 are accepted, the data is transferred to database 5 where it is stored.

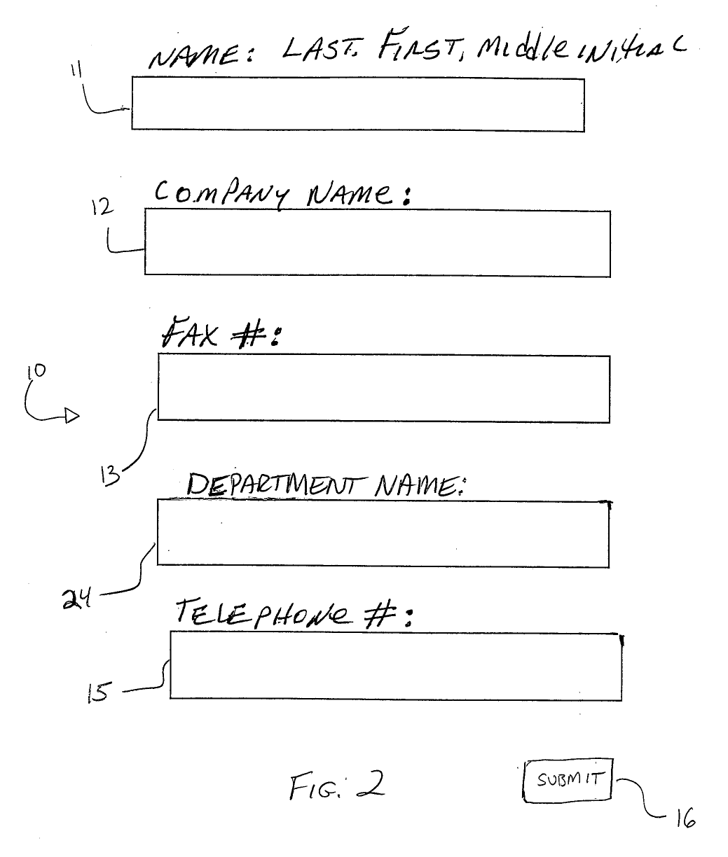

Registration module 2 then presents member 8 with a basic registration web page data entry template 10 as shown in FIG. 2. Basic registration web page data entry template 10 allows member 8 to enter the contact information that is to appear in the directory listing for member 8. Such information, in the preferred embodiment, includes member 8's name 11, business name 12 (if applicable), fax number 13, department name 24 (if applicable) and telephone number 15. Once the data is entered, member 8 may click on submit button 16 to cause the data to be transferred to database 5 where it is stored (602).

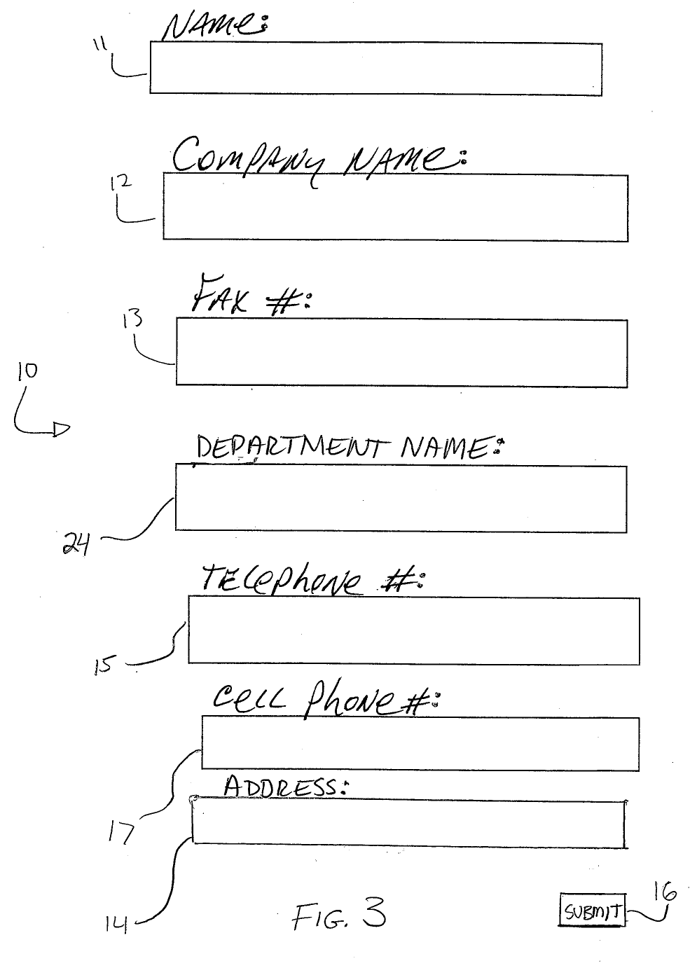

In some embodiments of the present invention, member 8 may choose to make additional contact information available in member 8's directory listing in the interactive electronic facsimile directory 1, such as a street address and a cell phone number. In such cases, as shown in FIG. 3 in the preferred embodiment, an enhanced registration web page data entry template 10 allows member 8 to enter member 8's name 11, business name 12 (if applicable), fax number 13, department name 24 (if applicable), telephone number 15, address 14 and cell phone number 17. Once the data is entered, member 8 may click on submit button 16 to cause the data to be transferred to database 5 where it is stored.

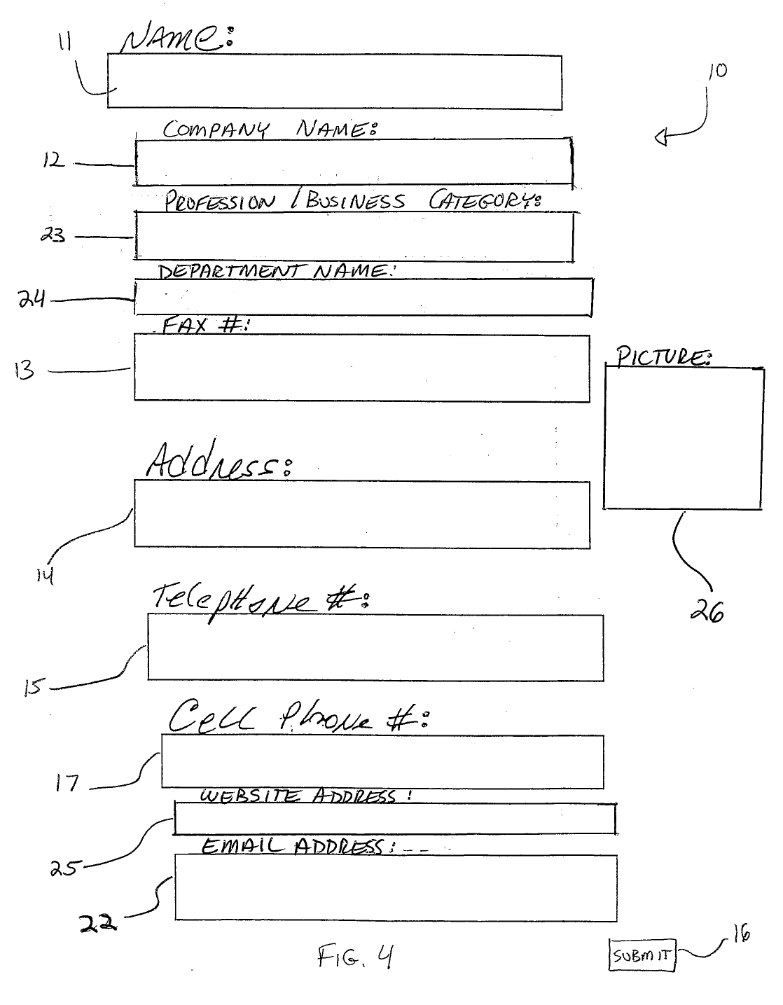

Similarly, in some embodiments of the present invention, member 8 may choose to make even more contact information available in member 8's directory listing in the interactive electronic facsimile directory 1, such as an email address, website address, picture and profession/business category. In such cases, as shown in FIG. 4 in the preferred embodiment, a premium registration web page data entry template 10 allows member 8 to enter member 8's name 11, business name 12 (if applicable), fax number 13, department name 24 (if applicable), telephone number 15, address 14, cell phone number 17, email address 22, profession/business category 23, website address 25 and a picture 26 (such as a photograph or a logo). Once the data is entered, member 8 may click on submit button 16 to cause the data to be transferred to database 5 where it is stored.

In some embodiments of the present invention, members 8 are charged a fee to list their fax numbers and other contact information in interactive electronic facsimile directory 1. In such embodiments, in addition to accepting member 8's name 11, business name 12, fax number 13, department name 24, telephone number 15, address 14, cell phone number 17, email address 22, profession/business category 23, website address 25 and/or picture 26, registration module 2 also accepts and database 5 stores payment information, such as a credit card number, using a similar data entry and storage method as previously described. In such embodiments, a payment processing gateway (not shown), as well known in the prior art, may be utilized to validate member 8's credit card information and process payments.

Login module 3 allows members 8 registered through registration module 2 to access and modify their information. When member 8 chooses to login in order to modify saved information (603 in FIG. 6), login module 3 presents member 8 with a user name and password web page data entry template (similar to template 21 in FIG. 5) and prompts member 8 to enter user name 18 and password 19 (604). In order to authenticate member 8 and permit member 8 to modify the saved information, login module 3 communicates user name 18 and password 19 to database 5.

Database 5 compares user name 18 and password 19 against the user names and passwords stored in database 5. After a successful match, database 5 communicates with login module 3 to transmit the saved information for authenticated member 8. Login module 3 then presents a summary of the saved information for authenticated member 8 in a template style similar to FIGS. 2-4 (the particular template dependent on the particular information that member 8 has chosen to make available-basic (FIG. 2), enhanced (FIG. 3) or premium (FIG. 4)). Member 8 may then make any desired changes to the information and, upon activation of submit button 16, login module 3 transmits the modified information to database 5 for storage (605).

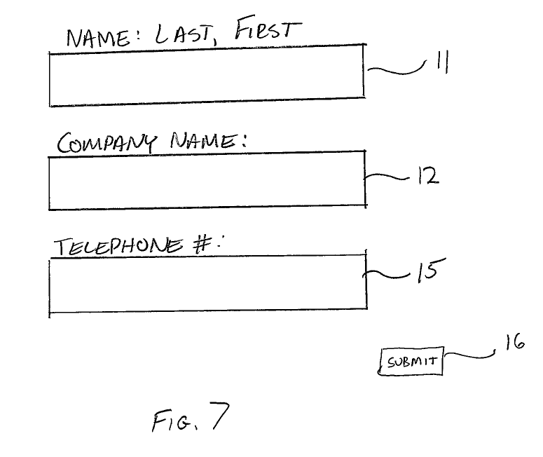

Search module 4 allows searchers 9 seeking to locate a fax number or other information of member 8 to search database 5. When searcher 9 chooses to search for a fax number or other contact information of member 8 (606), search module 4 presents searcher 9 with a member name web page data entry template (FIG. 7) and prompts member 8 to enter the name 11, business name 12 and/or telephone number 15 of member 8 (607). Searcher 9 may enter full or partial data for name 11, business name 12 and/or telephone number 15. For example, if searcher 9 does not know the full name or spelling of a business name, only the first few letters may be entered. Once the known data is entered, searcher 9 may click on submit button 16.

Search module 4 then communicates to database 5 the full or partial data for name 11, business name 12 and/or telephone number 15 as entered by searcher 9. Database 5 compares the full or partial data for name 11, business name 12 and/or telephone number 15 against the names, business names and/or telephone numbers stored in database 5 by member 8. After a successful match, database 5 communicates with search module 4 to transmit fax number 13 and other stored listing information for the matching member 8. Search module 4 then presents a summary of the fax number 13 and other stored listing information for matching member 8 in a read-only template style similar to FIGS. 2-4 (the particular template dependent on the particular information that member 8 has chosen to make available—basic (FIG. 2), enhanced (FIG. 3) or premium (FIG. 4)) (608).

Should the full or partial data for name 11, business name 12 and/or telephone number 15 as entered by searcher 9 return multiple matching members 8 (such as when searcher 9 enters a partial business name 12 shared by multiple members 8), search module 4 presents a summary list of members 8 sharing such full or partial data and permits searcher 9 to choose the desired member 8 from the list. Search module 4 then presents a summary of the fax number 13 and other stored listing information for the selected matching member 8 in the manner described above.

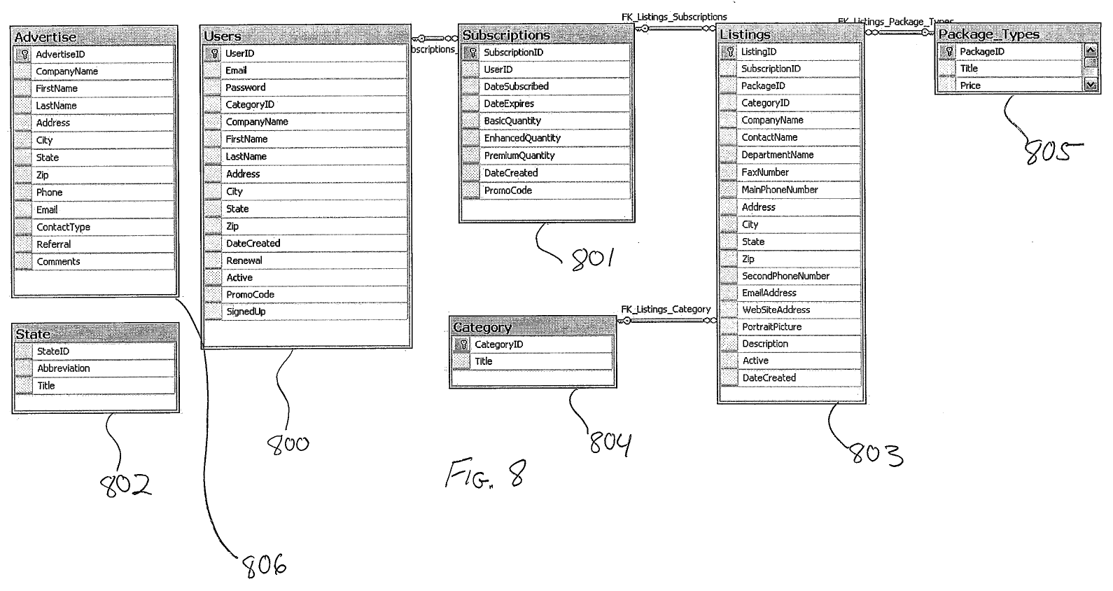

As shown in FIG. 8, database 5 comprises a plurality of different database tables (800-807) used to store various data related to registration module 2, login module 3 and search module 4. The design and structure of database 5 are well known in the prior art, namely database 5 comprises a normalized relational database wherein database 5 is programmed to store effectively different, but related, data for registration module 2, login module 3 and search module 4.

Specifically, in the preferred embodiment, users table 800 stores the following data, among other data, with respect to each member 8: user name 18 (“UserID”), email address (“Email”), password 19 (“Password”), profession/business category 23 (“CategoryID”), business name 12 (“CompanyName”), first name (“FirstName”), last name (“LastName”), address 14 (“Address,” “City,” “State” and “Zip”) and related information regarding the member 8's registration.

Listings table 803 stores the data for each member 8 that are used to generate the directory listings in response to a query by searcher 9. Specifically, in the preferred embodiment, listings table 803 stores the following data, among other data, with respect to each member 8: name 11 (“ContactName”), business name 12 (“CompanyName”), department name 24 (“DepartmentName”), profession/business category 23 (“CategoryID”), department (“DepartmentName”), fax number 13 (“FaxNumber”), telephone number 15 (“MainPhoneNumber”), address 14 (“Address,” “City,” “State” and “Zip”), cell phone number 17 (“SecondPhoneNumber”), email address 22 (“EmailAddress”), website address 25 (“WebSiteAddress”), picture 26 (“PortraitPicture”) and related information regarding the member 8's listing.

In some embodiments, subscriptions table 801 stores data regarding the member 8's chosen level of service—basic (“BasicQuanity”), enhanced (“EnhancedQuantity”) or premium (“PremiumQuantity”). In other embodiments, advertise table 806 stores data regarding advertisers who may purchase advertisements to display on the interactive facsimile directory of the present invention.

It should be understood, however, that the particular database schema shown in FIG. 8, and the particular tables with the database schema, may vary without departing from the scope of the present invention.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. An interactive facsimile directory comprising:
a registration module;
a login module;
a search module; and
a database;
wherein the registration module is designed to permit at least one member to add contact information to the directory;
wherein the login module is design to permit the at least one member to access and modify the contact information;
wherein the search module is designed to permit at least one searcher to search the directory for the contact information of the at least one member; and
wherein the database is designed to receive, transmit, and store data used by the registration module, the login module and the search module, the database being interactively coupled to the registration module, the login module and the search module.

2. The interactive facsimile directory of claim 1 wherein the contact information comprises at least a name and a facsimile number of the at least one member.

3. The interactive facsimile directory of claim 1 wherein the contact information comprises at least a name, an address and a facsimile number of the at least one member.

4. The interactive facsimile directory of claim 1 wherein the contact information comprises at least a name, an address, a telephone number and a facsimile number of the at least one member.

5. The interactive facsimile directory of claim 1 wherein the contact information comprises a name, an address, a telephone number, a facsimile number, a cellular phone number and an email address of the at least one member.

6. The interactive facsimile directory of claim 5 wherein the contact information further comprises a profession or a business category of the at least one member.

7. The interactive facsimile directory of claim 1 wherein the registration module is further designed to permit the at least one member to store payment information for adding the contact information to the directory.

8. The interactive facsimile directory of claim 1 wherein the login module is further designed to authenticate the at least one member prior to the at least one member accessing or modifying the contact information.

9. The interactive facsimile directory of claim 1 wherein the search module is further designed to permit the at least one searcher to search for the contact information using at least a portion of a name or a telephone number.

10. The interactive facsimile directory of claim 4 wherein the search module is further designed to permit the at least one searcher to search for the contact information of the at least one member using at least a portion of the name or the telephone number of the at least one member.

11. The interactive facsimile directory of claim 5 wherein the search module is further designed to permit the at least one searcher to search for the contact information of the at least one member using at least a portion of the name, the address, the telephone number, the cellular phone number or the email address of the at least one member.
